(19) United States
(12) Patent Application Publication
(10) Pub. No.: US 2016/0226603 A1
(43) Pub. Date: Aug. 4, 2016

(54) METHOD AND SYSTEM FOR VALIDATING INTERFERING SIGNALS

(71) Applicants: Alex Stephenne, Kanata (CA); Aaron Callard, Ottawa (CA)

(72) Inventors: Alex Stephenne, Kanata (CA); Aaron Callard, Ottawa (CA)

(21) Appl. No.: 14/609,892

(22) Filed: Jan. 30, 2015

(51) Int. Cl. H04B 17/15; H04B 17/24; H04B 17/29; H04B 17/23

(52) U.S. Cl. CPC H04B 17/15; H04B 17/23; H04B 17/24; H04B 17/29

(57) ABSTRACT

Systems, apparatus and methods for validating whether an interfering communications signal has been encountered by a node in a wireless communications network due to signals transmitted by a node operating in another wireless communications network. The wireless communications networks may operate as directional wireless communications networks. Signals transmitted by a node may include an indicator which is associated with a particular node or wireless link. The indicator or information used to generate the indicator may be provided to a third party such as a network operator or regulator. If a received signal includes an interfering signal transmitted by another node, a report of the interfering signal is validated by sending the indicator included in the signal to the third party to check against indicators of transmitting nodes.

### TECHNICAL FIELD

The present disclosure relates to wireless communications and more specifically, to methods and systems to validate an interfering communications signal.

### BACKGROUND

Signals between nodes in a communications network may interfere with the receipt of signals by other nodes in the network or with the receipt of signals by nodes in a different communications network. Interference may occur where the use of communication frequencies is unlicensed. As well, interference may occur despite the regulation and licensing of communications signals or while determining whether a particular frequency is available for use in a particular geographic location. The use of different communications frequencies may be licensed on the basis of a region, link or frequency channel or a combination of one or more of these parameters.

### SUMMARY

According to an embodiment of the present disclosure, there is provided a method for execution a first wireless communications node. The method includes determining that a received signal includes an interfering signal including an indicator associated with a second wireless communications node; and reporting the determined indicator.

According to an embodiment of the present disclosure, there is provided a method for execution a second wireless communications node. The method comprises transmitting a signal including a time varying indicator associated with the second wireless communications node.

According to an embodiment of the present disclosure, there is provided a wireless communications node. The node includes a wireless communications interface for receiving signals; a memory; and a processor. The processor is configured to determine that a received signal includes an interfering signal, the interfering signal including an indicator associated with a second wireless communications node; and report the determined indicator.

According to an embodiment of the present disclosure, there is provided a wireless communications node. The node includes a wireless communications interface for transmitting signals; a memory; and a processor. The processor is configured to transmit a signal including a time varying indicator associated with the second wireless communications node through the wireless communications interface.

According to an embodiment of the present disclosure, there is provided a method including receiving from a first wireless communications node, an indicator determined from an interfering signal received by the first wireless communications node; receiving from a second wireless communications node, an indicator included in a signal transmitted by the second wireless communications node; and comparing the indicators received from the first and second wireless communications nodes to validate whether the interfering signal received by the first wireless communications node originated from the second wireless communications node.

According to an embodiment of the present disclosure, there is provided a system for validating an interfering signal. The system includes a third wireless communications node configured to: receive, from a first wireless communications node, an indicator determined from an interfering signal received by the first wireless communications node; receive, from a second wireless communications node, an indicator included in a signal transmitted by the second wireless communications node; and compare the indicators received from the first and second wireless communications nodes to validate whether the interfering signal received by the first wireless communications node originated from the second wireless communications node.

### BRIEF DESCRIPTION OF THE DRAWINGS

Reference will now be made, by way of example, to the accompanying figures which show example embodiments of the present application, and in which:

FIG. 1 is a block diagram illustrating a communications node in accordance with one implementation of the present disclosure;

FIG. 2 is a block diagram illustrating a communications system in accordance with one implementation of the present disclosure;

FIG. 3 is a block diagram illustrating a method in accordance with one implementation of the present disclosure;

FIG. 4 is a block diagram illustrating a method in accordance with one implementation of the present disclosure; and

FIG. 5 is a block diagram illustrating a method in accordance with one implementation of the present disclosure.

Like reference numerals are used throughout the Figures to denote similar elements and features. While aspects of the invention will be described in conjunction with the illustrated embodiments, it will be understood that it is not intended to limit the invention to such embodiments.

### DETAILED DESCRIPTION OF EXAMPLE EMBODIMENTS

Interference between signals in a wireless network may be controlled through licensing or regulatory schemes which may vary based on jurisdiction, wireless technologies, and frequencies of communications signals. In the mobile spectrum, for example, different frequencies may be licensed to network operators for a particular geographical region. The E Band range of frequencies is an example of a spectrum which may be subject to a less stringent set of licensing restrictions since the directionality of the transmitted signal beam is high. Despite licensing schemes, or the use of directional signals, interfering signals may nevertheless occur. Changes in technology and an increased number of network operators or nodes attempting to share and increase the use of particular communication frequencies may further result in an increase of interfering signals, requiring a suitable coordination scheme for the efficient use of communication frequencies. For example, if the E Band spectrum is used for ultra-dense networks (UDNs), or for access links in addition to backhaul links, interference between links may increase and may require negotiation and/or sanctions against the operator of an interfering node.

The E Band is generally the range of radio frequencies from about 60 GHz to 90 GHz which are equivalent to wavelengths between 5.0 to 3.333 mm. In the United States, for example, the Federal Communications Commission has made frequencies between 71 to 76 GHz, 81-86 GHz and 92-95 GHz available for high-density fixed wireless services and link licenses may be obtained for particular transmitting and receiving coordinates, rather than obtaining a license for a geographic region. Other jurisdictions may allocate and license channels within each frequency band in addition to transmitting and receiving coordinates.

In other networks, such as but not limited to UDNs, 4G networks or 5G networks, nodes may have greater beam forming capabilities including switched beam forming or adaptive beam forming. The directionality of signals may be less static and interfering signals may occur as the direction of an antenna beam changes. While a regional approach to licensing may reduce the possibility of interfering signals, this would provide a less efficient use of resources since not all beams would be used at all time-frequency slots.

The present disclosure provides systems, apparatus and methods for validating whether an interfering communications signal has been encountered by a first node in a first communications network due to signals transmitted by a second node operating in a second communications network. The embodiments disclosed herein also may be applied to validate interference encountered by a first node in a first communications network due to signals transmitted by a second node in the same communications network. The networks and/or nodes may or may not be controlled by different operators. It will be understood that references to first and second nodes, transmitting and receiving nodes, and first and second communications networks are used for ease of description and do not limit the invention to signals transmitted in a particular direction or order, or to signals received by a specific number of nodes.

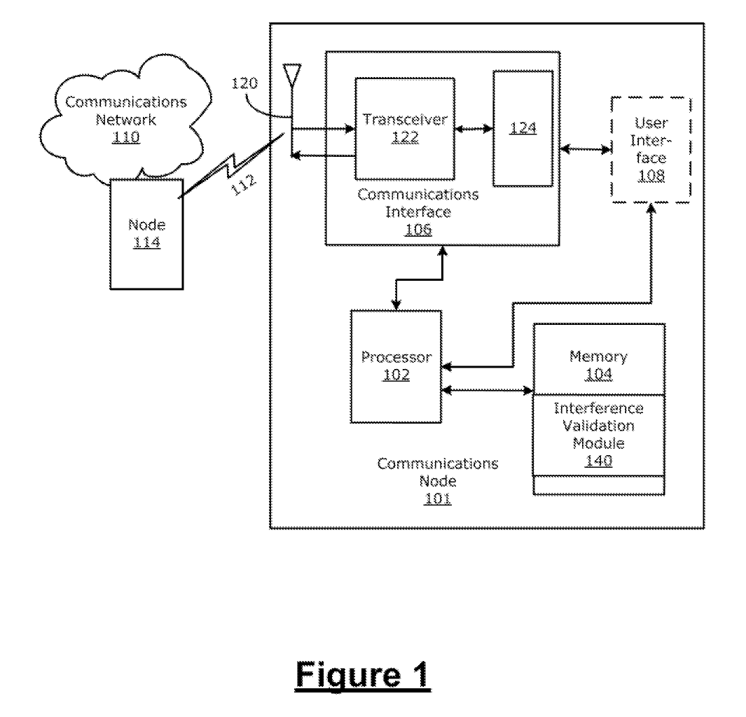

FIG. 1 illustrates a block diagram of an electronic communications node 101 which, in one embodiment, can detect an interfering signal and validate the interfering signal according to the present disclosure. In some embodiments, the wireless communications node 101 may be configured to associate an indicator with a wireless link and add the indicator to transmitted signals. In further embodiments, the communications node 101 can both detect and validate interfering signals, and associate and add an indicator to transmitted signals. The communications node 101 may include a processor 102, a memory 104, and a communications interface 106 for sending and receiving data over a communications network 110, which components may or may not be arranged as shown in FIG. 1. Through the communications interface 106, the node 101 may transmit, receive, or transmit and receive signals through a wireless medium 112 to and from another node 114 in the communications network 110. The communications interface 106 may include one or more antennas 120, transceivers 122, and a front end processing module 124 configured to provide beam forming including switched or adaptive beam forming. Signals received by the antenna 120 from the network 110 are input to the communications interface 106 which may perform such common receiver functions as signal amplification, frequency down conversion, filtering, channel selection, etc., as well as analog-to-digital (A/D) conversion. In a similar manner, signals to be transmitted are processed, including modulation and encoding, digital-to-analog (D/A) conversion, frequency up conversion, filtering, amplification, and transmission to the communications network 110 via the antenna 120. It will be appreciated that the functions of the communications interface 106 may be carried out by different transceiver or modem components including separate transmitter and receiver components (not shown).

In one embodiment, the node 101 includes a user interface 108 which may include a display, audio input and output, and keys, microphones or other inputs for receiving a command from a user. In one embodiment, the node 101 includes an operator interface (not shown) which allows the node 101 to be configured, monitored and/or controlled through the communications interface 106 or through a separate channel (not shown). The memory 104 may store programming and/or instructions for the processor 102 including instructions for implementing a interference validation module 140 as described herein, as well as instructions for implementing various applications as described herein. In one embodiment, software and/or hardware functionality for detecting and validating an interfering signal, or for performing a part of these functions, is included in the communications interface 106. In one embodiment, software and/or hardware functionality for associating an indicator with a wireless link and including the indicator in transmitted signals, or for performing a part of these functions, is included in the communications interface 106.

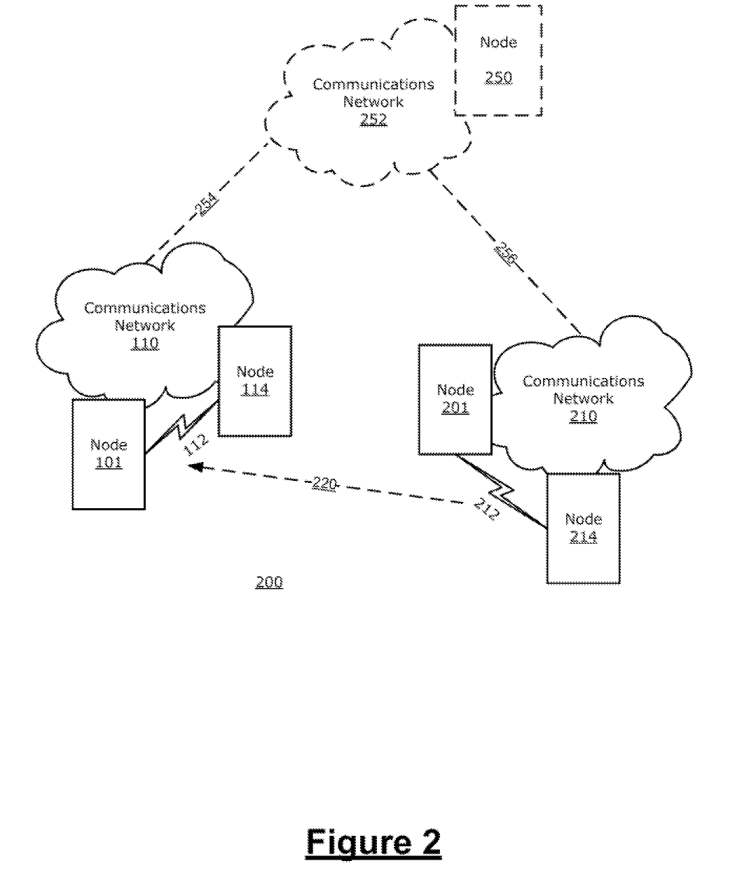

FIG. 2 provides a block diagram of one embodiment a system 200 according to the present disclosure including the communications network 110 and electronic communications nodes 101, 114, as well electronic communications node 201, 214 in a second communications network 210. The communications networks 110, 210 may comprise a wireless communications network or a combination of wired and wireless communications networks. The communications networks 110, 210 may operate according to one or more standards or technologies including but not limited to fourth generation (4G) telecommunications networks, Long-Term Evolution (LTE), 3rd Generation Partnership Project (3GPP), Universal Mobile Telecommunications System (UMTS) and other wireless or mobile communications networks. In some example embodiments, the communications networks 110, 210 may operate in a particular range of communication frequencies such as, but not limited to the E Band spectrum, or a white space of frequencies from a legacy broadcasting or radio spectrum. In one embodiment, the communications networks 110, 210 each comprise an ultra-dense directional wireless network (DWN).

The communications nodes 101, 114 represent any pair of nodes in the communications network 110 that transmit, receive, or transmit and receive signals to and from each other through the wireless medium 112. The communications nodes 101, 114 may include, for example, any one or combination of a backhaul node, relay node, gateway, access point, e-Node B (eNB) or base station. In one embodiment, the communications nodes 101, 114 include a user device and an access point, base station, eNB or other node which allows the user device to access the network 110. In one embodiment, one or both of the communications nodes 101, 114 are stationary.

The communications nodes 201, 214 represent any pair of nodes in the communications network 210 that transmit, receive, or transmit and receive signals to and from each other through a wireless medium 212. The communications nodes 201, 214 may include, for example, any one or combination of a backhaul node, relay node, gateway, access point, eNB or base station. In one embodiment, the communications nodes 201, 214 include a user device and an access point, base station, eNB or other node which allows the user device to access the network 210. In one embodiment, one or both of the communications nodes 201, 214 are stationary.

As represented in FIG. 2, signals transmitted by node 201 which are intended for receipt by node 214 may interfere with signals received at node 101, as represented by arrow 220. As described below, signals transmitted by nodes 101, 114, 201, 214 may include information which may be used to identify each signal beam transmitted by each node. In one embodiment, a third party, as represented by node 250 in communications network 252 has functionality to confirm the information associated with each signal beam and a corresponding identity associated with the transmitting node 101, 114, 201, 214. The node 250 may function to apply sanctions against links or nodes transmitting interfering signals and to coordinate the use of links, such as the use of links in a directional wireless network. Each of the communications networks 110, 210 may be connected to the communications network 252 through wired or wireless connections 254, 256. Thus, where the transmission of interfering signals may lead to consequences for an owner or operator of the network 110 or network 210, such as, for example, monetary penalties, reduced resources, denial of services, or a change in network configuration, a third party may be trusted with confirming the identity of the source of an interfering signal. In one embodiment, the third party associated with the node 250 is a network operator or a regulator or licensor of frequency band used by the communications networks 110, 210. In another embodiment, one or more of nodes 101, 114, 201, 214 or another node (not shown) in communications networks 110, 210 has functionality to confirm the information associated with each signal beam and a corresponding identity associated with the transmitting node 101, 114, 201, 214. Where, for example, each of communications networks 110, 210 is associated with the same owner or operator, or there is a trust relationship between operators of the networks 110, 210, interfering signals may be detected and resolved without the use of a third party.

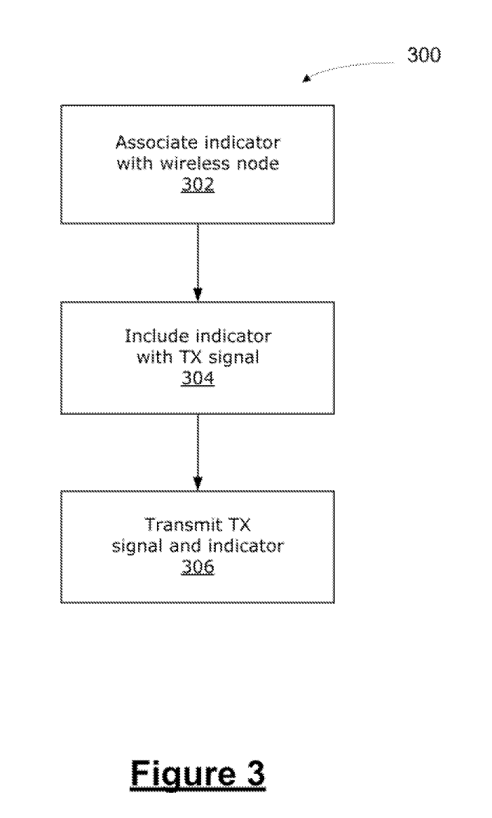

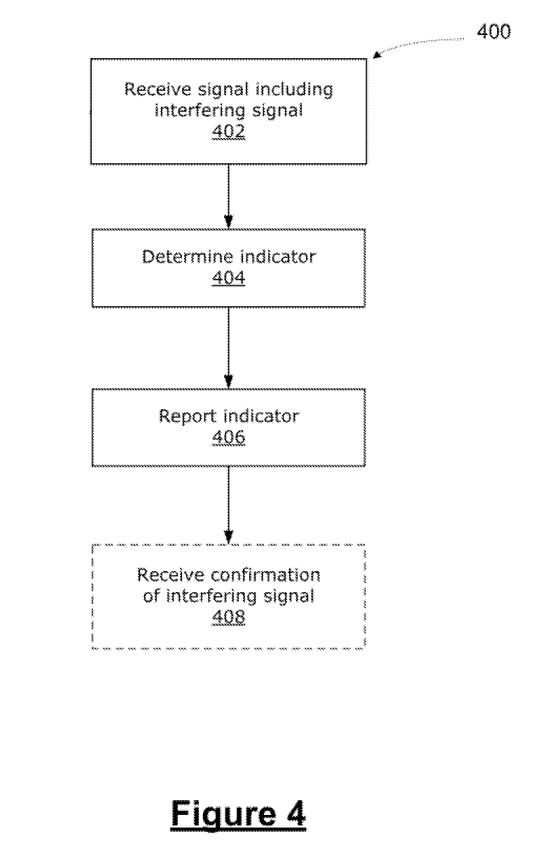

In one embodiment as illustrated in FIGS. 3 and 4, methods 300, 400 are provided for validating an interfering signal. The method 300 includes a communications node, such as communications node 201, associating an indicator with a wireless link (Action 302). In one embodiment, the indicator identifies wireless communications signals sent by the node 201, or a wireless communications signal sent by the node 201 over a particular wireless link or channel. In one embodiment, the indicator may identify wireless communications signals sent by a node 201 of a particular network operator, user, vendor, manufacturer, or a certain model of the node 201, or a combination thereof. In a further embodiment, the indicator may uniquely identify wireless communications signals sent by the node 201, or a wireless communications signal sent by the node 201 over a particular wireless link or channel. The action 302 of associating the indicator may include storing the indicator in memory in association with information identifying the node 201, or identifying the node 201 and the wireless link such as a time, a frequency, a steered beam direction, and a beam source location such as originating coordinates. The action 302 of associating the indicator may include sending or providing the indicator to a third party, such as node 250, along with identifying information including but not limited to frequency, a steered beam direction, the location of the node, the name of the owner or operator of the node, the name of the manufacturer or vendor of the node, a time, or a beam source location such as originating coordinates, or a combination thereof. The action 302 of associating the indicator may include sending or providing the indicator to a node within the communications network 210 and/or to a node within the communications network 110. In some embodiments, the action of storing the indicator in memory or providing the indicator to the node 250 or other nodes within the networks 110, 210 may comprise storing or providing a seed which comprises information or a shared cryptographic key from which the indicator for a wireless link may be generated. Alternatively, the indicator or seed may be provided by the node 250 to the node 201. Further options may include where the indicator or seed are provided to both the node 250 and the node 201 from another party. In the method 300, the indicator is included in the signal which is being transmitted over the wireless link (Action 304) and transmitting the signal including the indicator (Action 306), such as by transmitting the signal through the wireless medium 212 to node 214. In some embodiments, one or more indicators may be associated with corresponding wireless links for the transmitting node 201 after signals have been transmitted.

The method 400 includes a communications node, such as communications node 101 receiving a signal at its communications interface 106 (Action 402). The received signal may include a signal intended for the communications node 101, such as a signal sent by node 114, and an interfering signal received due to a transmission by another wireless node, such as node 214, as represented by arrow 220. Interference may be determined while node 101 is attempting to receive data from node 114 simultaneously as node 201 is transmitting data to node 214. Interference may be determined as a result of signal degradation or block errors, or if interference measured either at the receive port or using a specific receiver is above a predetermined threshold.

In one embodiment, a sounding phase is used periodically or as needed to determine whether interfering signals exist and to create an interference map. During the sounding phase, time-frequency resource blocks may be dedicated to a single link each, at any given time, and possibly interfered links may be listening on those resources in order to determine whether interfering signals are present. A sounding phase may be tailored between network operators for use in identifying suspected interfering links or links previously identified as interfering. The sounding phase may correspond with existing initial access or beam finding procedures.

Once an interfering signal is determined to have occurred at node 101, the interference validation module 140 and communications interface 106 operate to determine or decode an indicator associated with the interfering signal (Action 404). The indicator is then reported (Action 406) to a third party, such as 250.

The node 250 may compare the reported indicator with indicators received from transmitting nodes, including communications node 201. Alternatively, the node 250 may compare the reported indicator with one calculated based on a seed received from the node 201, the seed comprising information or a shared cryptographic key from which the indicator for a wireless link of node 201 may be generated. In other embodiments it may be the node 250 which determines and provides the indicator values to a transmitting node 201, or which determines and provides the seed to the transmitting node 201. A hybrid approach in which a portion of the indicator is determined by the node 250, and a portion by the node 201 also may be used. Interference may be substantiated or validated if a match exists between the reported indicator from the interfering signal and the indicator stored or generated by the node 250. Thus, where the transmission of an interfering signal may lead to consequences for the owner or operator of the network 210, interference is evidenced by the indicator detected by the node 101 rather than being based on a possibly false or malicious allegation of signal interference which may lead to unnecessary consequences for the source of the alleged interfering signal. The node 250 may be configured to take other actions in response to the interfering signal to report sanctions against, deny services or cause changes to the network 210 or to the node 201 transmitting the interfering signal. In one embodiment, the node 101 or an operator of the node 101 receives a message from the node 250 confirming that the interfering signal has been validated. A similar message may be provided to the node 201 or to an operator of the node 201 regarding the validated interference. In another embodiment, the node 250 may take action to report sanctions against, deny services or cause changes to the network 110 or to the node 101 which receives and sends excessive reports of allegedly interfering signals which are not validated.

In one embodiment, the indicator which is included in a transmitted signal comprises a pseudo-random sequence created by or provided to the node 201 and assigned to the wireless link. As described above, where the node 201 is part of a directional wireless network and includes beam switching capabilities, a different pseudo-random sequence may be embedded in each directional transmission. In one embodiment, the indicator is embedded in every N^{th} directional transmission or periodically in various directions. As described above, once sent, the pseudo-random sequence for a particular node and wireless link are known to the transmitting node 201 and receiving node 214 (from the example above) and may be provided to the node 250 but the pseudo-random sequence is not known to other nodes, and thus cannot be used by unintended recipients which are not part of the network 210 to create allegations of interference. In one embodiment, a time-varying pseudo-random sequence is used so that the sequence cannot be taken and re-used by other nodes or devices at a later time. In one embodiment, the indicator comprises a combination of a pseudo-random sequence or time-varying pseudo-random sequence and other identifiers associated with the node 201 or the wireless link.

In one embodiment, the indicator of the wireless link transmitted by node 201 is known to a third entity, such as node 214 in the same communications network 210 as node 201, and may be used as a reference signal or as a pilot signal for receipt of communications through the wireless medium 212. In one embodiment, the indicator may comprise a sequence embedded in each transmission as a preamble. The sequence may be embedded using resources in time-frequency and/or code spreading. In other embodiments, the sequence may be transmitted independently from other communications.

In one embodiment, the indicator may be embedded into a transmitted signal as a beacon similar to that used in IEEE 802.11 standards in which a known preamble is transmitted followed by data encoded and modulated using known parameters. For example, some fixed pilots may be used followed by encoded data using a specific forward error correction (FEC) code (Convolutional, Turbo, Low-density parity-check (LDPC) etc.) with known parameters (interleaver, puncturing pattern, rate etc.). This transmitted signal may not be directly tied to any particularly data transmission.

In one embodiment, the indicator may be embedded into a transmitted signal for a regular data transmission. Using pre-assigned resource mapping, certain resources within a transmission may be used for transmission of the data, i.e. the first OFDM symbol, interleaved across a transmission uniformly (similar to pilots), or on certain frequency tones. Various forms of physical layer signal transmissions could be used, such as but not limited to orthogonal frequency-division multiplexing (OFDM) or single-carrier frequency-division multiple access (SC-FDMA).

In one embodiment, to reduce the overhead of this signal the receiver of node 214, (which is aware of the indicator) may use that information to use the resource assigned for the indicator as pilots. To enable a receiver of node 101 which is not aware of this information to decode the indicator, some additional pilots may be present which are not modulated by the indicator information. Alternatively, the data may be encoded non-coherently so that it may be decoded without the aid of additional pilots. Hybrid solutions are also possible and in one embodiment, cyclic redundancy checks (CRCs) may be attached such that accurate decoding of the FEC code could be verified.

In one embodiment, a maximum receive power level is defined above which an interfering signal may be reported. Thus, the action 406 of reporting an indicator may first include a step of determining the received power level of the interfering signal and reporting the indicator if the power level is above a predetermined threshold. In some embodiments, reporting of an indicator is made regardless of whether or not a receive power threshold has been exceeded or whether the interfering signal has affected the receipt of other signals. In one embodiment, the actions 302, 304 of associating and including the indicator with the signal to be transmitted may comprise multiple indicators, such as multiple pseudo-random sequences, which are then transmitted (action 306) at different power levels. When the node 101 detects an interfering signal, its ability to determine one or more of the multiple indicators provides an indication of the possible level of interference based on which indicator(s) was detected. Thus, in one embodiment, the interfering signal comprises multiple indicators, and determining the indicator from the interfering signal comprises determining one or more of the multiple indicators at different receive power levels.

In one embodiment, the indicator is encoded using a scalable coding approach. Where the receiver in the communications interface 106 of node 101 is listening on the same frequency as the interfering signal (namely the signal transmitted by node 201 to node 214) the indicator may be decoded and the number of layers decoded may provide an indication regarding the level of interference. If the interfering signal is on an adjacent frequency, such that the interference is an out-of-band emission spilling from the channel used by the transmitter at node 201, to the frequency used by the receiver at node 101, the node 101 is configured to look onto the interfering frequency to detect the indicator of the interfering signal. In this embodiment, an automatic gain control (AGC) module of the receiver of node 101 is configured to control the input amplitude to a level which prevents the analog-to-digital converter (ADC) from being saturated. The AGC module thus may have a wide dynamic range.

In one embodiment, such as during a sounding phase as described above, a transmit power for the indicator embedded in each directional transmission may be set to a transmit power of a reported interfering signal to ensure that the indicator may be detected. The transmit power for the indicator may be set to a level slightly above the maximum received power level at which interference may be reported and may vary depending on the modulation and coding used for the indicator signal. In one embodiment, the node 101 which is detecting interference is configured not to transmit signals on the link experiencing interference. In one embodiment, during operation or a sounding phase, the communications interface 106 at node 101 is configured to instruct a scheduler associated with the link encountering interference to be silent. Such steps may help to ensure that the indicator may be detected from the interfering signal by the node 101.

In some embodiments, in addition to the indicator described above, the signals transmitted by the node 201 may include information of an identity associated with the node 201, its communication links, signals beams or the identity of the owner or operator of the node 201 and/or communications network 210. In one embodiment, the signals transmitted by the node 201 include information which the node 101 may use to determine the identity associated with the node 201, its communication links, signals beams or the identity of the owner or operator of the node 201 and/or communications network 210. Thus, in one embodiment, the node 101 can determine an identity associated with the node 201 which is transmitting an interfering signal beam. When reporting an indicator (Action 406) of an interfering signal such as to the node 250, the node 101 also may transmit the identity associated with the interfering signal to assist the node 250 in matching the reported indicator to the transmitting node 201.

In some embodiments, such as where a single operator or owner controls both network 110 and network 210, or where the operators or owners of each network 110, 210 have a trust relationship, the indicator detected from an interfering signal, and any additional identity information contained in the signal, may be exchanged between the networks 110, 210 and used by each operator to validate possible interfering links and to test and reconfigure links accordingly. Nodes within the networks 110, 210 may receive the indicators, or seeds used to generate the indicators, and identity information associated with each transmitted signal beam from node 201. The node 101 reporting an indicator or an indicator and identity information from the interfering signal may transmit this information to the other node(s) within the networks 110, 210. In one embodiment, the networks 110, 210 communicate through a secondary channel, such as but not limited to an internet connection.

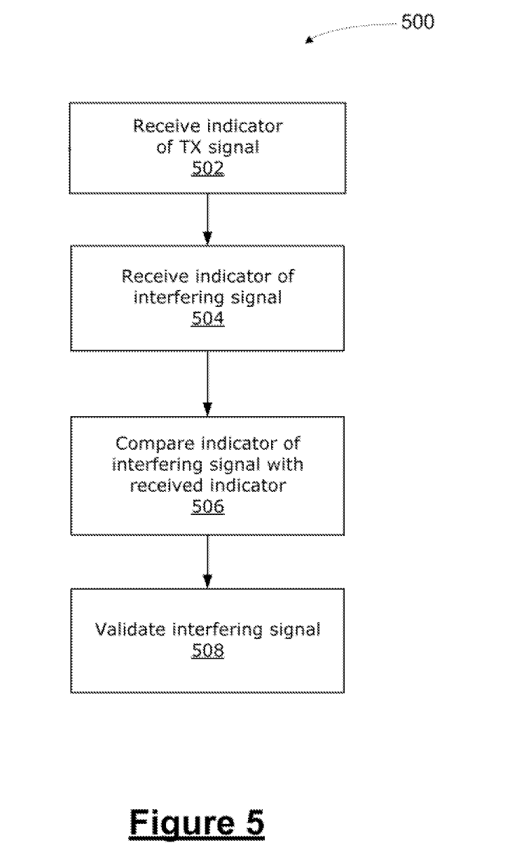

FIG. 5 illustrates an embodiment of a method 500 of validating an interfering signal by a node in a network, such as the node 250. The method includes receiving an indicator (Action 502) from one or more wireless communications nodes transmitting signals in one or more wireless communications networks. In one embodiment, the indicator is received by the node 250 in the form of a seed which comprises information or a key used to generate the indicator. Each indicator is used to identify wireless communications signals sent by the node, or a wireless communications signal sent by the node over a particular wireless link or channel. In one embodiment, the indicator may identify wireless communications signals sent by a node 201 of a particular network operator, user, vendor, manufacturer, or a certain model of the node 201, or a combination thereof. In a further embodiment, the indicator may uniquely identify wireless communications signals sent by the node 201, or a wireless communications signal sent by the node 201 over a particular wireless link or channel. In one embodiment, receiving an indicator includes storing the indicator or the seed for generating the indicator in a memory along with information identifying the wireless communications node, or the wireless communications node and wireless link, which will be transmitting signals including the indicator. Such indentifying information may include but is not limited to frequency, a steered beam direction, the location of the node, the name of the owner or operator of the node, a time, or a beam source location such as originating coordinates, or a combination thereof. In one embodiment, the node 250 may receive a message relating to a number of indicators used by a wireless communications node along with associated information identifying the node and its wireless communications links.

The method 500 further includes receiving an indicator (Action 504) from a wireless communications node which determines it has received an interfering signal from the transmissions of another wireless communications node. The indicator associated with the alleged interfering signal is compared (Action 506) with the received or generated indicators for transmitted signals. The alleged interfering signal may be validated (Action 508) if a match is found between the indicator associated with the interfering signal and an indicator associated with a transmitting node. In one embodiment, the method further includes sending a message or signal to the wireless communications node or operator of the node which sent the interfering signal and/or to the wireless communications node or operator of the node which received the interfering signal. The message or signal may be used to indicate whether or not the interfering signal has been validated. Thus, based on information such as an indicator which is used by a transmitting wireless communications node and the sharing of the indicator, or a seed which may be used to generate the indicator, with another node, such as the node 250, allegations of interfering signals received by a wireless communications node in another network can be validated to confirm the source of interference.

Through the descriptions of the preceding embodiments, the present invention may be implemented by using hardware only, or by using software and a necessary universal hardware platform, or by a combination of hardware and software. Based on such understandings, the technical solution of the present invention may be embodied in the form of a software product. The software product may be stored in a non-volatile or non-transitory storage medium, which can be a compact disk read-only memory (CD-ROM), USB flash drive, or a hard disk. The software product includes a number of instructions that enable a computer device (personal computer, server, or network device) to execute the methods provided in the embodiments of the present invention.

Although the present invention and its advantages have been described in detail, it should be understood that various changes, substitutions and alterations can be made herein without departing from the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for execution at a first wireless communications node, the method comprising:
determining that a received signal includes an interfering signal including an indicator associated with a second wireless communications node; and
reporting the determined indicator.

2. The method of claim 1 wherein the indicator comprises a time-varying pseudo-random sequence.

3. The method of claim 1 wherein the received signal comprises a directional wireless communications signal.

4. The method of claim 1 wherein determining that the received signal includes the interfering signal comprises silencing transmissions by the first wireless communications node over a wireless link associated with the received signal.

5. A method for execution at a second wireless communications node, the method comprising:
transmitting a signal including a time varying indicator associated with the second wireless communications node.

6. The method of claim 5 wherein the indicator is encoded with the transmitted signal using a scalable coding approach.

7. The method of claim 5 wherein the indicator is included in the transmitted signal as a reference signal.

8. The method of claim 5 further comprising transmitting the signal including the indicator during an idle period or during an interference test phase.

9. The method of claim 5 wherein the indicator comprises a time-varying pseudo-random sequence embedded in the transmitted signal.

10. The method of claim 5 further comprising transmitting multiple signals in a directional wireless network wherein the indicator included in each transmitted directional signal comprises a different pseudo-random sequence.

11. The method of claim 5 further comprising sending information identifying the associated second wireless communications node and one of the indicator, or a seed used to generate the indicator, to a third communications node.

12. The method of claim 11 wherein the information identifying the second wireless communications node comprises any one or a combination of a model, vendor, manufacturer, network operator or user of the second wireless communications node.

13. A wireless communications node, comprising:
a wireless communications interface for receiving signals;
a memory; and
a processor configured to:
determine that a received signal includes an interfering signal, the interfering signal including an indicator associated with a second wireless communications node; and
report the determined indicator.

14. A wireless communications node, comprising:
a wireless communications interface for transmitting signals;
a memory; and
a processor configured to:
transmit a signal including a time varying indicator associated with the wireless communications node through the wireless communications interface.

15. A method for validating an interfering signal, the method comprising:
receiving from a first wireless communications node, an indicator determined from an interfering signal received by the first wireless communications node;
receiving from a second wireless communications node, an indicator included in a signal transmitted by the second wireless communications node; and
comparing the indicators received from the first and second wireless communications nodes to validate whether the interfering signal received by the first wireless communications node originated from the second wireless communications node.

16. The method of claim 15 wherein the indicator received from the second wireless communications node is in the form of a seed used to generate the indicator included in the signal sent by the second wireless communications node, the method further comprising generating an indicator from the seed, comparing the generated indicator with the indicator received from the first wireless communications node, and in response to a match, validating interference by the second wireless communications node.

17. A system for validating an interfering signal, the system comprising:
a third wireless communications node configured to:
receive, from a first wireless communications node, an indicator determined from an interfering signal received by the first wireless communications node;
receive, from a second wireless communications node, an indicator included in a signal transmitted by the second wireless communications node; and
compare the indicators received from the first and second wireless communications nodes to validate whether the interfering signal received by the first wireless communications node originated from the second wireless communications node.

18. The system of claim 17 wherein the indicator received from the second wireless communications node is in the form of a seed used to generate the indicator included in the signal transmitted by the second wireless communications node.

19. The system of claim 17 wherein the first and second wireless communications nodes are each located within respective first and second directional wireless communications networks.

20. The system of claim 19 where in the third wireless communications node is located within one of the first or second directional wireless communications network.

21. The system of claim 17 wherein the third wireless communications node is located within a third communications network.

22. The system of claim 17 wherein the first and second wireless communications nodes are stationary.

23. The system of claim 17 comprising the second wireless communications node, the second wireless communications node being configured to generate and include the indicator in signals sent thereby and to also independently send the indicator, or a seed used to generate the indicator, to the third wireless communications device.

24. The system of claim 17 comprising the first wireless communications node, the first wireless communications node being configured to determine the indicator from the interfering signal and send the determined indicator to the third wireless communications node.
